(19) United States
(12) Patent Application Publication
(10) Pub. No.: US 2026/0104028 A1
(43) Pub. Date: Apr. 16, 2026

(54) METHODS AND DEVICES FOR CONVERTING A COMPRESSED AIR ENERGY STORAGE (CAES) INTO A HYDROELECTRIC POWER STORAGE SYSTEM

(71) Applicant: POWER8 TECH INC., Los Gatos, CA (US)

(72) Inventors: LIEN CHUN DING, Taoyuan (TW); CHIH CHENG TAI, Campbell, CA (US)

(21) Appl. No.: 19/354,667

(22) Filed: Oct. 9, 2025

Related U.S. Application Data
(60) Provisional application No. 63/706,170, filed on Oct. 11, 2024.
(60) Provisional application No. 63/847,911, filed on Jul. 21, 2025.

(51) Int. Cl. F03B 13/06; B29C 63/10; B29L 31/00

(52) U.S. Cl. CPC F03B 13/06; B29C 63/10; B29L 2031/7156; F05B 2260/422; F05B 2280/6003

(57) ABSTRACT

The present disclosure provides energy storage systems using hydroelectric power generator. The systems are able to be modified from a compressed air energy storage system (CAES). The method of converting a compressed air energy storage system into a hydroelectric power storage system can be achieved by coupling a pump to one or more containers constructed for storing compressed air of a compressed air energy storage and coupling a hydroelectric power generator to the one or more containers. The method further comprises constructing a fluid pipe connecting the pump and the one or more container. Further, the method constructs a fluid pipe connecting the hydroelectric power generator and the one or more container.

### CROSS-REFERENCE TO RELATED APPLICATIONS

This application claims priority to U.S. Provisional Application No. 63/706,170, filed on Oct. 11, 2024, and entitled “METHODS AND DEVICES FOR CONVERTING A COMPRESSED AIR ENERGY STORAGE (CAES) INTO A HYDROELECTRIC POWER STORAGE SYSTEM.” This application also claims priority to the U.S. Provisional Application No. 63/847,911, filed on Jul. 21, 2025, and entitled “A FIRE PREVENTION AND REDUCTION SYSTEM USING AN ENERGY STORAGE SYSTEM.” All of the above are incorporated herein by reference for all purposes.

### FIELD OF THE INVENTION

The present disclosure relates to the field of energy storage. Specifically, the present disclosure relates to energy storage systems and methods using hydroelectric power storage system.

### BACKGROUND OF THE INVENTION

Nowadays, burning coal and nuclear energy are often used to generate electricity, but the carbon dioxide produced from burning coal and the reaction materials used in nuclear energy are very harmful to the environment. Although green power generation may be more environmentally friendly, its efficiency is usually affected and limited by climate and environmental conditions, and the cost of power generation is usually high. Therefore, if a power storage method or system is to achieve both environmental protection and high power generation efficiency at the same time, it is very difficult with current technology.

To overcome the disadvantages described above, the present disclosure provides an energy storage method and system. Compared with traditional electrical energy generation methods, the heterogeneous pressure media and interactive actuation module, as well as the heterogeneous pressure media and interactive actuation energy storage system of the present disclosure, are operated in a closed circulatory system.

### SUMMARY OF THE INVENTION

The present disclosure provides an energy storage system and method using heterogeneous pressure media and interactive actuation modules.

In some embodiments, an energy storage (e.g., a heterogeneous pressure media and interactive actuation module) is provided, wherein a first container is provided for setting an initial first gas (IG) and a second container is provided for setting an initial fluid (IL) (e.g., gas or liquid). When an additional working liquid (e.g., pumped fluid, such as water) is pumped into the second container, which in term pressurizes the initial first gas. The pressure increased gas serves as an energy storage media. When in a power generation mode (energy release), the initial fluid (IL), the working liquid (WL), or both is driven/pushed out by the increased air pressure to flow to/drive a hydrogenerator, which generates electricity. The processes of pressuring the gas (e.g., energy storage) and using the pressure to drive water for hydropower generation (e.g., electricity generation) serve as a function of energy storage and release.

Compared with the traditional electrical energy generation method, the heterogeneous pressure media and interactive actuation module and the heterogeneous pressure media and interactive actuation energy storage system of the present disclosure can be performed in a closed circulatory system.

The present disclosure has at least the following advantages:
(a) Easily obtainable raw materials: The initial first gas, initial fluid, and working fluid used in the present disclosure are natural existing substances, such as water, ambient air and other substances, which can be easily obtained.
(b) Flexible planning of electrical energy: The present disclosure provides a modular design, which can be used to build micro, small, medium and large power plants according to actual electrical energy requirements to provide, for example, as small as kilowatts (kW) to gigawatts (GW) (and above) of electrical energy.
(c) Efficient use of space: The energy storage system of the present disclosure can be installed underground or under buildings, hence not occupying the original use space and capable of reducing the impact of the external environment.
(d) Safely generating electrical energy: The energy storage system of the present disclosure does not use dangerous substances and thus can be installed in residential houses, schools, cities, public facilities and other fields.
(e) Low maintenance cost: The present disclosure uses substances that can be easily obtained from the environment, such as water, ambient air and other substances. Therefore, when the efficiency is reduced, the original energy storage and discharge efficiency can be restored simply by adding/refilling at least one of the initial gas, initial fluid, and working fluid, without the need to purchase natural gas, coal, and nuclear transformation. materials, etc.
(f) Automatic control systems: The present disclosure provides a controller to switch between the first operation mode and the second operation mode using the control valve to manipulate and control the movement of the initial gas, the initial fluid and the working liquid.
(g) Power grid compatibility: The present disclosure drives the converter to generate electrical energy (or electricity) through energy (such as pressure energy, hydraulic energy, etc.), which can directly transmit/transfer the electrical energy to the existing power grid system, and can be used as the main source of power or as backup power in the power grid system.
(h) Residual power storage and conversion: The present disclosure stores residual/unused power or backup power for emergency supplemental use, which is collectively referred to as residual electricity. The present disclosure uses residual power to drive pumps, so as to convert residual electricity into pressure energy by the heterogeneous pressure media and interactive actuation module to achieve the effect of storing residual electricity, and the present disclosure can instantly convert the pressure energy into electrical energy to make up for the insufficient electricity any time according to the increased demand of electricity.
(i) Conversion of the existing storage containers of the Compressed Air Energy Storge (CAES) into the hydropower generator disclosed herein-providing an economically feasible and ready-to-use systems.

### BRIEF DESCRIPTION OF THE DRAWINGS

FIG. 1 is a three-dimensional schematic diagram of an energy storage container of an energy storage in accordance with some embodiments.

FIG. 2(a) is a schematic diagram illustrating an operation of the energy storage executing a first operation mode (e.g., energy storage) of FIG. 1 in accordance with some embodiments.

FIG. 2(b) is a schematic diagram illustrating the operation of the energy storage executing a second mode of operation (e.g., energy release/electricity generation) of FIG. 1 in accordance with some embodiments.

FIG. 3 is a three-dimensional schematic diagram of the energy storage in accordance with some embodiments.

FIG. 4(a) is a schematic diagram illustrating the operation of the energy storage of FIG. 3 in accordance with some embodiments.

FIG. 4(b) is a schematic diagram illustrating the operation of the energy storage executing a second operation mode of FIG. 3 in accordance with some embodiments.

FIG. 5 is another three-dimensional schematic diagram of the energy storage in accordance with some embodiments.

FIG. 6 is three-dimensional schematic diagram of the energy storage system in accordance with some embodiments.

FIG. 7 is a three-dimensional schematic diagram of the energy storage system in accordance with some embodiments.

FIG. 8 is a three-dimensional schematic diagram of the energy storage system in accordance with some embodiments.

FIG. 9 is a schematic flow chart of a method for energy storage using a heterogeneous pressure media and interactive actuation in accordance with some embodiments.

FIG. 10 is a schematic diagram illustrating the application of the energy storage system of FIG. 7 of a power network in accordance with some embodiments.

FIG. 11 illustrates the converting of a system of compressed air energy storge (CAES) into a hydroelectric power storage system in accordance with some embodiments.

FIG. 12 illustrates another embodiment of converting a system for compressed air energy storge (CAES) into a hydroelectric power storage system in accordance with some embodiments.

FIG. 13 illustrates a device for converting compressed air energy storage into a hydroelectric power storage system in accordance with some embodiments.

FIG. 14 illustrates an energy storage apparatus in accordance with some embodiments of the present disclosure.

FIG. 15 is a cross-sectional view of a mixing tank according to an embodiment of the present disclosure.

FIG. 16 is a schematic diagram of a mixing tank.

FIG. 17 is a flow chart illustrating a method for manufacturing an energy storage.

### DETAILED DESCRIPTION OF THE PREFERRED EMBODIMENTS

In order to fully understand the purpose, features and effects of the present invention, the following specific embodiments are used in conjunction with the accompanying drawings to give a detailed description of the present invention. The description is as follows:

In this specification, “a” or “an” is used to describe the units, elements and components described herein. This is just for the convenience of illustration and provides a general meaning to the scope of the present invention. Therefore, unless clearly stated otherwise, this description should be understood to include one or at least one, and the singular number also includes the plural number.

In this specification, the terms “include”, “comprise”, “have” or any other similar terms are intended to cover non-exclusive inclusions. For example, an element, structure, product or device that contains a plurality of features is not limited to the requirements listed herein, but may include those features that are not explicitly listed but are generally inherent in the element, structure, product or device. In addition, unless there is a clear statement to the contrary, the term “or” refers to the inclusive “or” rather than the exclusive “or”.

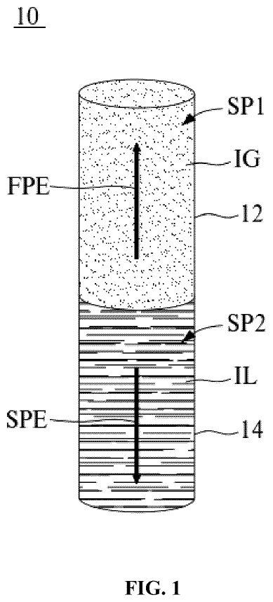

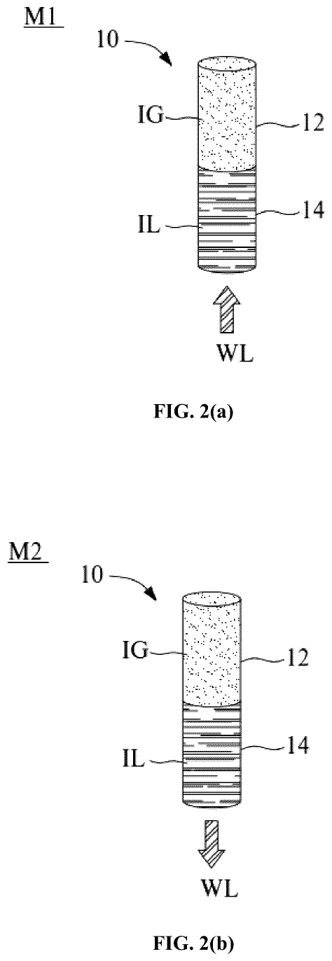

Please refer to FIG. 1, which is a three-dimensional schematic diagram of the energy storage in accordance with some embodiments. In FIG. 1, the energy storage 10 comprises a heterogeneous pressure media and interactive actuation module executes a first operation mode M1 (e.g., energy storage) and a second operation mode M2 (e.g., electricity generation). In FIG. 2(a) and FIG. 2(b), the energy storage 10 executes the first operation mode M1 (e.g., energy storage) and the second operation mode M2 (e.g., electricity generation). FIG. 2(a) is a schematic diagram illustrating the operation of the energy storage executing a first operation mode (e.g., energy storage) in FIG. 1. FIG. 2(b) is a schematic diagram illustrating the operation of the energy storage executing a second operation mode (e.g., electricity generation) of FIG. 1.

In some embodiments, when the first operation mode M1 (e.g., energy storage) is executed, the first container 12 of the energy storage 10 receives the working liquid WL from the liquid source 2. Next, when the second operation mode M2 (e.g., electricity generation) is executed, the energy storage 10 is couple with the converter 4 and is pushing the working liquid WL, IL (initial liquid), or both to the converter 4. In an example, the converter 4 is a hydropower generator, liquid pump, a turbo pump, a liquid generator, a liquid turbine generator, a hydraulic turbine generator, or the like.

The first operation mode M1 and the second operation mode M2 are operated in different time periods. For example, the first operation mode M1 is executed during the off-peak electricity consumption period and the second operation mode M2 is executed during the peak electricity consumption period. Furthermore, in other embodiments, for example, when there are multiple energy storages, the first operation mode M1 and the second operation module M2 can be executed simultaneously at the same time.

In FIG. 2(a), the first operation mode M1 refers to that when the first operation mode M1 is executed, a working liquid WL is injected into the energy storage 10. In addition, the working liquid WL may come from a liquid source. For example, the liquid source may be a water tank, a reservoir, a water tower, etc., which can serve as a device or equipment for storing the working liquid WL. In FIG. 2(a), the arrow represents the flow path of the working liquid WL.

In FIG. 2(b), the second operation mode M2 refers to that when the second operation mode M2 is executed, the working liquid WL, initial liquid IL, or both is discharged from the energy storage 10, so that when the energy storage 10 is connected to, for example, a converter (e.g., an hydroelectric generator), the working liquid WL, initial liquid IL, or both can be discharged to the converter to drive the converter to operate and generate electricity.

The working liquid WL, initial liquid IL, or both can be water in accordance with some embodiments. Other fluids or liquids are also within the scope of the present disclosure, such as organic solvents, inorganic solvents, molten salts, fluid ionic salts, supercritical fluids, and various gases or other flowable substances or pressure-generating substances and mechanisms, etc.

Referring to FIG. 1, the energy storage 10 includes a first container 12 and a second container 14. Although the first container 12 and the second container 14 are referred to as containers, such terms should not be used to limit the scope to a specific shape; as long as it can be used to contain liquid, gas or solid and can bear the generated pressure thereof at the same time. In addition, the material and thickness of the first container 12 and the second container 14 can also affect/determine the applicable pressure, liquids, gases, or solids. For example, the material/structure can be stainless steel, iron, concrete, soil, ground or the like. In addition, it is worth noting that the energy storage 10 may be installed underground or enclosed by other materials (such as cement, concrete, steel, or a combination thereof... etc.). For example, when the first container 12 and the second container 14 are encapsulated by cement, the first container 12 and the second container 14 can increase the strength of resistance against pressure. In other words, the enclosure by cement or concrete can reduce the thickness/material requirements of the walls of the containers. Similarly, an underground system of the present disclosure also reduces the thickness/material requirements of the walls of the containers.

The first container 12 forms a first space SP1 to store an initial first gas IG. Here, the first container 12 is illustrated with a cylindrical tank body as an example. In other embodiments, the first container 12 may also be a petrol tank, gas tank, stainless steel tank or plastic tank or other shapes.

In some embodiments, the initial first gas IG contains air, other fluids or gases are also within the scope of the embodiments, such as hydrogen, helium, nitrogen or mixed gases (such as 20% hydrogen and 80% helium), etc., as well as various gases or other flowable substances or substances and mechanisms that can generate pressure. In addition, the initial first gas IG may also be transformed from other material states, for example, the gas state is transformed from a solid-state or a liquid state. The foregoing transformation may occur, for example, through changes in temperature, pressure, etc. In some other embodiments, the initial first gas IG may not only stay in the first space SP1 but may also appear in the second space SP2. Moreover, the initial first gas IG may not fill the entire first space SP2 in some embodiments. In some other embodiments, in addition to filling the entire first space SP1, the initial first gas IG may also fill a part or all of the space SP1, SP2, or both.

The second container 14 is disposed of on one side of the first container 12. Here, the second container 14 is disposed of on the lower side of the first container 12 as an example. In other embodiments, the second container 14 may be disposed of on either side of the first container 12, that is, it is not limited to be disposed of on the lower side. The second container 14 forms a second space SP2, generating pressure energy by the heterogeneous pressure media between the first space SP1 and the second space SP2.

In some embodiments, the second space SP2 further stores an initial liquid IL, so the pressure level in the second space SP2 can be increased faster than without initial liquid IL. After the second container 14 is connected to the first container 12, the second space SP2 connects with the first space SP1. Here, the second container 14 is also illustrated with a cylindrical tank body as an example, and the description thereof can refer to the description of the first container 12, which will not be repeated here. Furthermore, the shape of the second container 14 may be the same as or different from the shape of the first container 12. In other embodiments, the initial liquid IL may not only stay in the second space SP2 but also appear in the first space SP1. Moreover, in addition to filling the entire second space SP2, the initial liquid IL may also fill a part or all of the space SP1, SP2, or both.

In some embodiments, the initial liquid IL may be water/air as one of the embodiments. Other fluids or liquids are also within the scope of the embodiments of the present invention, such as organic solvents, inorganic solvents, molten salts, fluid ionic salts, supercritical fluids, and various gases or other flowable substances or pressure-generating substances and mechanisms, etc. Furthermore, the material used for the initial liquid IL may be the same or different from that of the working liquid WL. In addition, the initial liquid IL may also be transformed from other material states, for example, the liquid state is transformed from a solid state or a gas state. The foregoing transformation may occur, for example, through changes in temperature, pressure, etc.

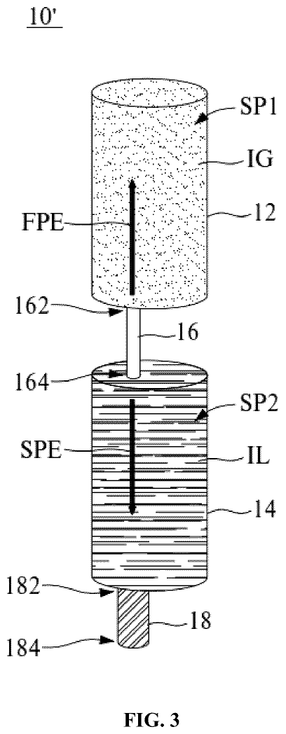

In FIG. 3, different from FIG. 1, the energy storage 10′, in addition to the first container 12 and the second container 14 mentioned in the earlier described embodiment, further includes a first tube 16 and a second tube 18.

In some embodiments, the first tube 16 provides a first end 162 and a third end 164. The first end 162 is coupled to the first container 12 and the third end 164 is coupled to the second container 14 so that the first tube 16 communicates with the first space SP1 and the second space SP2.

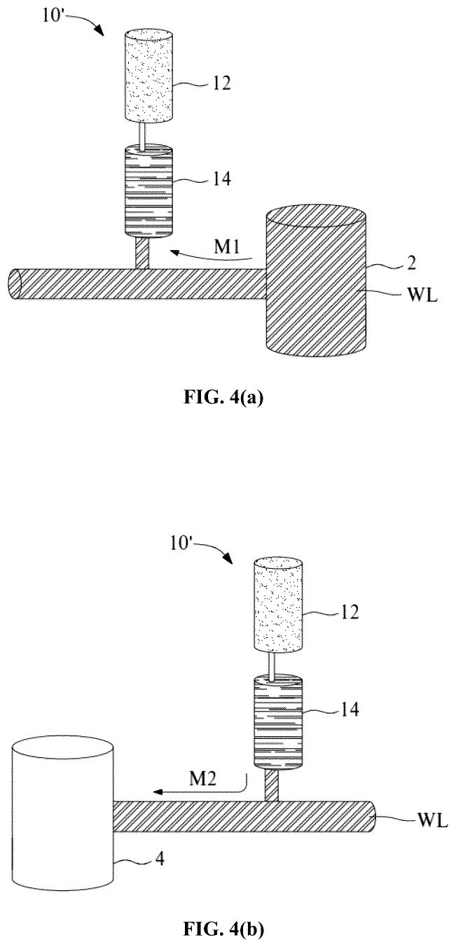

In some embodiments, the second tube 18 provides a second end 182 and a fourth end 184. The second end 182 is coupled to the second container 14 and the fourth end 184 can be connected to the converter 4 as shown in FIG. 4(b) and the liquid source 2 as shown in FIG. 4(a).

As shown in the FIG. 3 to FIG. 4(a), when the first operation mode M1 (e.g., energy storage) is executed, the working liquid WL stored in the liquid source 2 is continuously injected into the second space SP2 through a second tube 18, so that the injected working liquid WL gradually increases the space occupied in the second space SP2 by gradually increasing the volume in the second space SP2, thereby compressing the initial first gas IG in the first space SP1 through the first tube 16, until the initial first gas IG in the first space SP1 reaches a predetermined pressure and stores as a first pressure energy (FPE). In some embodiments, the second space SP2 further filled with the initial liquid IL, so the injection of the working liquid WL continually compresses the initial liquid IL, causing the pressure level of the second space SP2 increased rapidly to enhance the storage efficiency of the first pressure energy (FPE). Since the distance between the molecules of the initial first gas IG is reduced due to the expansion of the initial liquid IL, so that the initial first gas IG is compressed to achieve the effect of energy storage. The value of the predetermined pressure can range from several kilopascals to several megapascals. For example, the value of the predetermined pressure may range from 4 megapascals (Mpa) (or N/m2) to 12 Mpa. As long as the initial liquid IL thrust continues to occur, the initial first gas IG will continue to be compressed until the initial liquid IL no longer pushes the initial first gas IG due to pressure balance or the initial first gas IG can no longer be compressed, then the gas IG will stop being compressed. In addition, the pressure of the initial first gas IG can be reached or maintained at a predetermined pressure by adjusting the initial liquid IL to push the initial first gas IG, thereby determining the amount of the first pressure energy FPE (e.g., the energy state of the initial pressure of the initial first gas IG - first pressure energy FPE=the amount of energy stored).

Continuing to FIG. 4(b), when the second operating mode (e.g., electricity generation mode) is executed, the first pressure energy FPE compressing the air in the second space SP2 to drive the working liquid WL, the initial liquid IL or both discharging from the second space SP2 toward the opposite direction. For example, the working liquid WL, the initial liquid IL or both are pushed to the converter 4 (e.g., hydro generator), which originates from the effect of pressure release caused by the continuous expansion of the compressed initial first gas IG. In other words, the initial first gas IG drives the initial liquid IL, working liquid WL, or both to discharge, so as to convert the first pressure energy (FPE) into a second pressure energy (SPE) to drive the converter 4, and the converter 4 is acted on by the first pressure energy (FPE) until to the second pressure energy SPE to generate electrical energy E (or electricity).

In an embodiment, the energy storage 10′ working on a pressure therebetween maintained at several MPa to tens of MPa can generate electricity ranging from 30 kW (kilowatt) to 300 kW. For example, a single unit of energy storage generates 300 kW. About 750,000 kW of electricity can be generated, when 2,500 units of energy storage are used in a system. Each of the first container 12 or the second container 14 is 1 to 2 m height and 7 to 20 m length. For example, 1 m (height)×7 m (length), 1.5 m (height)×10 m (length), 2 m (height)×10 m (length) or 3 m (height)×20 m (length).

In an embodiment, when the first container 12 and the second container 14 is 1 m(height)×7 m (length), generating 30 kW of the electricity; when the first container 12 and the second container 14 is 1 m (height)×10 m (length), generating 42.9 kW of the electricity; when the first container 12 and the second container 14 is 1 m (height)×15 m (length), generating 64.3 kW of the electricity. It is disclosed that the electricity generating efficiency is related to the size of the first container 12 or the second container 14.

For the description of the energy storage 10′ executing the first operation mode M1 and the second operation mode M2, please refer to FIG. 4(a) and FIG. 4(b) together. Wherein, FIG. 4(a) is a schematic diagram illustrating the operation of the energy storage of the embodiment of FIG. 3 executing the first operation mode (e.g., energy storage); and FIG. 4(b) is a schematic diagram illustrating the operation of the energy storage of the embodiment of FIG. 3 executing the second operation mode (e.g., electricity generation).

Referring FIG. 2(a) to FIG. 4(b), in an embodiment, the technical features of the first tube 16 and the second tube 18 can be used to adjust the first operation mode M1 and the second operating mode M2 as follows:

In the first operation mode M1, the working liquid WL from the liquid source 2 is continuously injected into the second space SP2 via the second tube 18, so that the working liquid WL drives the initial liquid IL through the first tube 16 to continuously compress the initial first gas IG in the first space SP1 until the initial first gas IG in the space SP1 has a predetermined pressure, so that the first container 12 stores the first pressure energy (FPE). Since the distance between the molecules of the initial first gas IG is reduced by the initial liquid IL, the initial first gas IG is compressed to achieve energy storage. In some embodiments, initial liquid IL is optional, and initial first gas IG can include both the initial first gas IG and initial liquid IL.

In the second operation mode, the working liquid WL is no longer continuously injected into the second space SP2 through the second tube 18, but is discharged from the second tube 18 in the reverse direction. At this time, the compressed initial first gas IG continuously expands and causes the initial liquid IL to be pushed by the first pressure energy FPE to cause the working liquid WL, initial liquid IL, or both to push toward the converter 4(In the other embodiment, the second space SP2 isn't filled with the initial liquid IL). Thus, the initial first gas IG drives the initial liquid IL moving toward and discharges from the fourth end 184 of second tube 18, to convert the first pressure energy (FPE) into a second pressure energy (SPE), which drives the converter 4. The converter 4 that is driven by the second pressure energy (SPE) generates electrical energy E (e.g., electricity).

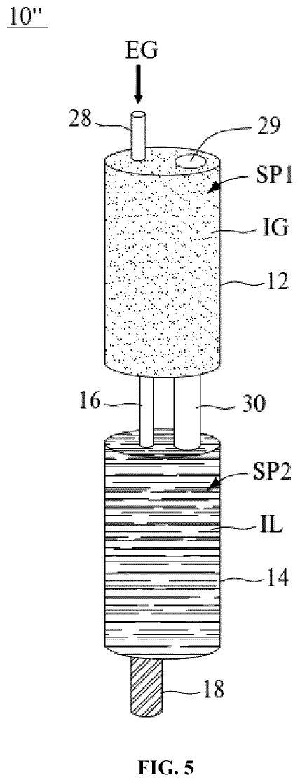

Referring to FIG. 5, a three-dimensional schematic diagram of the energy storage according to an embodiment. In FIG. 5, the energy storage 10″ not only includes the first container 12, the second container 14, the first tube 16 and the second tube 18 of the second embodiment, but also includes a third tube 28, a hole cover 29 and a maintenance pipe 30.

The descriptions of the first container 12, the second container 14, the first tube 16 and the second tube 18 are the same as the description of the other embodiment and will not be repeated here.

The third tube 28 is disposed of at the first container 12. One end of the third tube 28 is coupled to the first space SP1 and the other end of the third tube 28 is for receiving the external gas EG to supply the initial first gas IG. In another embodiment, the third tube 28 further includes a pressure safety valve (also called a pop-up valve) (not shown) used for selectively releasing gas or liquid to release the pressure, to adjust the pressure to reach the predetermined pressure setting value. For example, the pressure safety valve is controlled to maintain a predetermined pressure of the energy storage at 4 MPa (or N/m 2) to 12 MPa.

The hole cover 29 is disposed of at the first container 12. By opening the hole cover 29 to connect the first space SP1 with the outside space of the first container 12 and by closing the hole cover 29 to block the connection between the first space SP1 and the outside space of the first container 12, maintenance can be performed by the person (not shown in the figure) entering the first space SP1. In another embodiment, the hole cover 29 may further include a pressure safety valve (also called a pop-up valve) (not shown) used for selectively releasing gas or liquid to release pressure, so as to adjust the pressure safety valve so that the pressure of the first container 12 is maintained at a predetermined pressure value of, for example, several megapascals and several megapascals.

In another embodiment, the energy storage 10″ may further include a pressure sensor, a pump, a valve body, a controller, etc., which will be described in detail in the following embodiments.

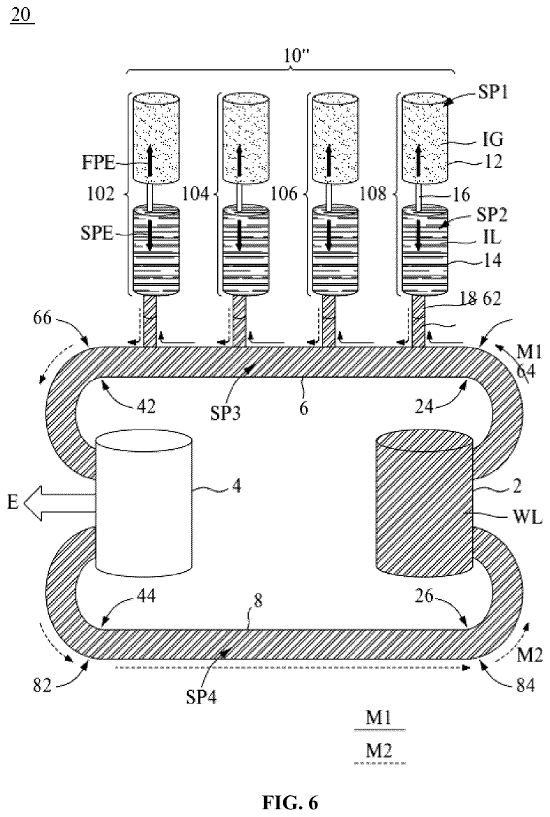

Please refer to FIG. 6, which is a three-dimensional schematic diagram of the energy storage system according to an embodiment. In FIG. 6, the heterogeneous pressure media and interactive actuation energy storage system 20 includes a plurality of energy storages 10″, a liquid source 2 (e.g., a pump or a pump connected to a water supply), a converter 4 (e.g., a hydroelectric power generator), a first pipe 6 and a second pipe 8. Here, the energy storage 10″, the liquid source 2, the converter 4, the first pipe 6 and the second pipe 8 form a closed and circulating energy storage and release structure according to the flow path of the working liquid WL.

Here, the energy storages 102, 104, 106 and 108 are illustrated by 4 units as an example. In other embodiments, the number can be arbitrarily selected, for example, the range of the number may be between 10 and 100 energy storages 10″, 100 and 1,000 energy storages 10″, or 1,000 and 999,999 energy storages 10″. Here, the energy storages 102, 104, 106 and 108 include first containers 12, second containers 14, first tubes 16 and second tubes 18. In addition, in some embodiments, the energy storages 102, 104, 106 and 108 may be added to or removed from the heterogeneous pressure media and interactive actuation energy storage system 20 in real-time or on-demand. Or the energy storages 102, 104, 106 and 108 may be controlled through the valve body to determine whether to operate (deemed as added) or not to operate (deemed as removed) in the energy storage system 20.

The first container 12 forms a first space (SP1) to store an initial first gas IG. The second container 14 is disposed of on the lower side of the first container 12, and the second container 14 forms a second space (SP2). In some embodiments, the second space (SP2) stores an initial liquid IL.

One end of the first tube 16 is coupled to the first container 12 and the other end of the first tube 16 is coupled to the second container 14, so that the first tube 16 connects with the first space (SP1) and the second space (SP2).

One end of the second tube 18 is coupled to the second container 14 and the other end of the second tube 18 is coupled to the first pipe 6. Wherein, the diameter of the second tube 18 may be larger or smaller than the diameter of the first tube 16.

The liquid source 2 supplies and recycles the working liquid WL. For example, the liquid source 2 may be a reservoir, a water tower, a reservoir, and the like. Wherein, the function of the liquid source 2 functioning as a supply can be referred to as the description of the prior embodiment, which will not be repeated here. Here, in addition to the function of supply, the liquid source 2 can also recycle the working liquid WL outputted by the converter 4 through the second pipe 8.

The converter 4 receives and outputs the working liquid WL. For example, the converter 4 may include a liquid pump, a turbo pump, a liquid generator, a liquid turbine generator, a hydro turbine generator, or other liquid driven device configured to generate electricity. When the converter 4 functions as a supply, reference may be made to the description of the prior embodiment, which will not be repeated here. Here, in addition to the function of supplying, the liquid source 2 can also recycle the working liquid WL outputted from the converter 4 through the second pipe 8.

The first pipe 6 forms a third space (SP3), and the first pipe 6 has a plurality of connection ports 62, a first connection point 64, and a third connection point 66. Each of the connection ports 62 connects each of the second spaces (SP2) and each of the third spaces (SP3). In addition, the first connection point 64 and the third connection point 66 are formed at the two ends of the first pipe 6. The first connection point 64 is coupled to the first end 24 of the liquid source 2 and the third connection point 66 is coupled to the first end 42 of the converter 4.

The second pipe 8 forms a fourth space SP4, and a first end 82 of the second pipe 8 is coupled to a second end 44 of the converter 4 and a second end 84 of the second pipe 8 is coupled to the second end 26 of the liquid source 2.

In some embodiments, during the first operation mode (M1), the working liquid WL from the liquid source 2 is injected into the second space (SP2) through the first pipe 6 and the second tube 18, so that the working liquid WL drives the initial liquid IL through the first tube 16 to continuously compresses the initial first gas IG in the first space SP1 or second space SP2 until the initial first gas IG acting on the first space SP1 has a predetermined pressure, thereby enabling the first container 12 to store a first pressure energy FPE.

In operation, in an energy storage mode, the working liquid WL is gradually inputted into the second space (SP2) from the first pipe 6 through the second tube 18, wherein the initial first gas IG takes the entire SP1+SP2 before the working liquid WL is inputted into the SP2. As the working liquid WL enters the SP2, the pressure of the initial first gas IG goes up, because the space of IG is reduced through the gradual input of water (or working liquid WL). The second space (SP2) can be from a fully empty or partially empty space to become full of liquid (e.g., initial liquid IL+working liquid WL). In some embodiments, the second space (SP2) can be filled up with all liquid (initial liquid IL+working liquid WL) and leaving all the initial first gas IG in the first space (SP1)

In the second operation mode M2, the initial first gas IG continuously expands to drive the initial liquid IL, working liquid WL or both moving toward and discharge from the second tube 18 to convert the first pressure energy FPE into a second pressure energy SPE and pass through the first pipe 6 to drive the converter 4 to generate an electrical energy E; and the working liquid WL after driving the converter 4 returns to the liquid source 2 through the second pipe 8.

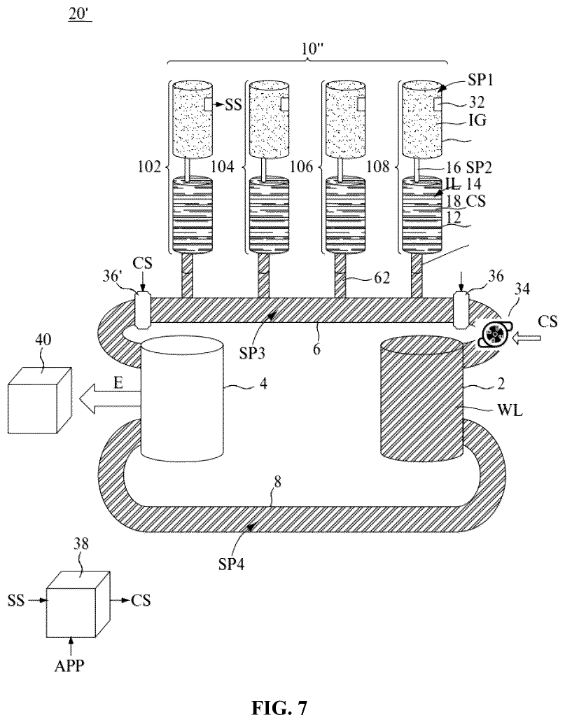

Referring to FIG. 7, a three-dimensional schematic diagram of the energy storage system is provided according to an embodiment. In FIG. 7, the energy storage system 20′ includes not only the energy storage 10″, the liquid source 2, the converter 4, the first pipe 6 and the second pipe 8, but also a pressure sensor 32, a pump 34, a valve body 36, and a controller 38. The pump 34 enables the heterogeneous pressure media and interactive actuation energy storage system to have a better energy storage effect, storing and releasing more energy.

The description of the energy storage 10″, the liquid source 2, the converter 4, the first pipe 6 and the second pipe 8 are the same as the description of the earlier embodiment and will not be repeated here.

The pressure sensor 32 can be used to sense, for example, changes in the working liquid WL, the initial liquid IL or the initial first gas IG and generate a corresponding sensing signal SS. Here, the pressure sensor 32 is disposed of at the first container 12 as an example. In other embodiments, the pressure sensor 32 may also be disposed of at least one of the second container 14, the first tube 16, the second tube 18, the first pipe 6 and the second pipe 8.

The pump 34 can be used to adjust, for example, the flow rate of the working liquid WL or the initial liquid IL. The pump 34 herein can be specially designed to provide the working liquid WL to generate a higher flow rate and pressure to act on the initial liquid IL and the initial first gas IG, and energy can be quickly and readily stored in the first container 12 and the second container 14. Herein, the pump 34 is disposed between the first pipe 6 and the liquid source 2 as an example. In other embodiments, the pump 34 may also be disposed of at least one of the first space SP1, the second space SP2, the first tube 16, the second tube 18, between the first tube 16 and the first container 12, between the second tube 18 and the second container 14, the first pipe 6, the second pipe 8, between the second pipe 8 and the liquid source 2, and between the second pipe 8 and the converter 2. In addition, the pump 34 regulates the working liquid WL of the liquid source 2 to enter the energy storage 10″.

The valve bodies 36, 36′ can provide an open mode and a closed mode manually and automatically. The automatic control can be done via the control signal CS. The control signal CS can be generated from the controller 38. Moreover, in the open mode, the working liquid WL, the initial liquid IL and the initial first gas IG can pass through the valve bodies. In the closed mode, the working liquid WL, the initial liquid IL and the initial first gas IG are stopped by the valve bodies. Herein, taking the valve body 36 between the first pipe 6 and the liquid source 2 and the valve body 36′ between the first pipe 6 and the converter 4 as an example for description, in other embodiments, the valve body may also be disposed at the at least one of the first container 12, the second container 14, the first tube 16, the second tube 18, between the first tube 16 and the first container 12, between the second tube 18 and the second container 14, the first pipe 6, the second pipe 8, between the second pipe 8 and the liquid source 2, and between the second pipe 8 and the converter 4.

The controller 38 may receive a sensing signal SS generated by the pressure sensor 32 from sensing the pressure generated by, for example, the working liquid WL, the initial liquid IL or the initial first gas IG. The controller 38 generates a control signal (CS) according to the sensing signal SS to operate the valve bodies 36, 36′ to further execute the open mode or the closed mode. In detail, the controller 38 outputs the control signal (CS) to operate the valve body 36 to control the initial first gas IG at a predetermined pressure, and when the initial first gas IG has a predetermined pressure, the initial first gas IG stops to be compressed.

In another embodiment, the controller 38 can control the control program APP to allow the energy storages 102, 104, 106 and 108 to store the first pressure energy (FPE) or convert the second pressure in a synchronous manner. For example, the controller 38 controls the valve body 36 so that the four energy storages 102, 104, 106 and 108 can simultaneously store about four times the first pressure energy FPE, or the four energy storages 102, 104, 106 and 108 can simultaneously release about four times the second pressure energy (SPE).

In yet another embodiment, the controller 38 can also control a control program APP to allow the energy storages 102, 104, 106 and 108 to store the first pressure energy (FPE) or convert the second pressure energy (SPE) asynchronously. For example, the controller 38 controls the valve body 36 or individually controllable valves at connection ports 62 (not shown) so that any of the energy storages 102, 104, 106 and 108 can independently store or release energy. In other words, the controller 38 can select one, more or all of the energy storages to drive the converter to generate one or several times the electrical energy or extend the duration for the electrical energy E to generate electricity.

In another embodiment, the controller 38 monitor the amount of electrical energy E generated. For example, when an abnormality (such as insufficiency or overload) occurs in the electric power, the controller 38 issues an abnormal notification.

In another embodiment, the controller 38 is capable of configuring electrical energy E, so as to supply electrical energy required in the energy storage 10 to achieve the purpose of self-generation and self-supply.

In another embodiment, the energy storage 10 further includes an extended energy storage unit 40 connected to the converter 4 to store electrical energy E. The extended energy storage unit 40 may be, for example, a storage battery, a secondary battery, a supercapacitor, or the like.

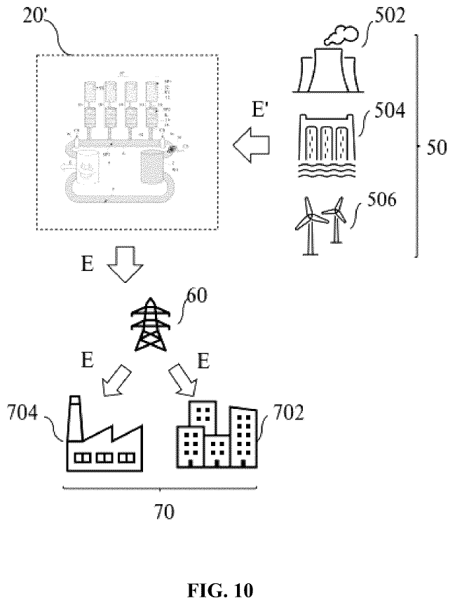

In another embodiment, referring to FIG. 10 together, it is a schematic diagram illustrating the application of the energy storage system of FIG. 7 to a power network. The energy storage system 20′ is used as the energy storage device of the existing power generation source 50. For example, the power generation source 50 may be thermal power generation 502, hydroelectric power generation 504 or wind power generation 506, nuclear power, geothermal energy, tidal energy, etc. The power generation source 50 generates electrical energy E′, and the electrical energy E′ can further drive the pump 34 of the heterogeneous pressure media and interactive actuation energy storage system 20′ to allow the pump 34 to operate the working liquid WL to store energy in the energy storage 10″. According to the power demand of the electrical energy 70 (such as residential electricity 702, industrial electricity 704, etc.), the energy storage 10″ can be matched with or support the power generation source 50, or be the main alternative power source, supplying the electrical energy E to the electrical energy demand 70 through the electric power network 60 at any time.

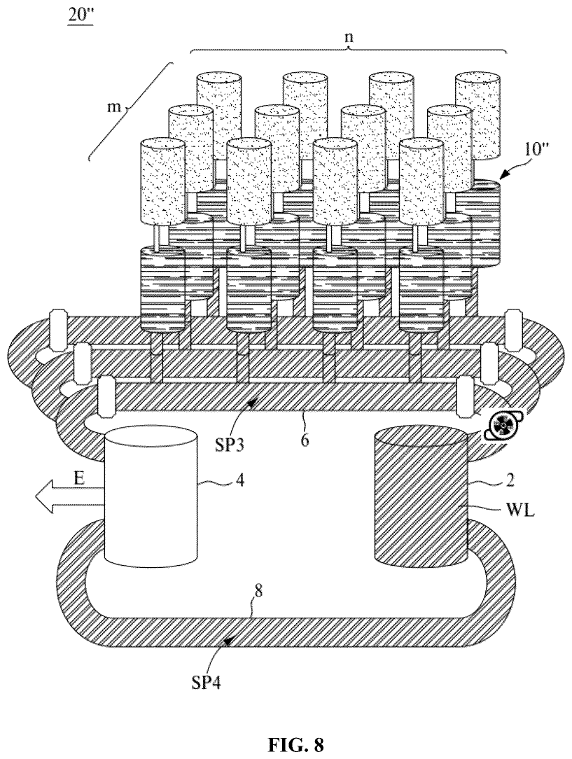

In another embodiment, the energy storage system 20″ contains n×m energy storages 10″, which can also be referred to as shown in FIG. 8, which is the three-dimensional schematic diagram of the energy storage system.

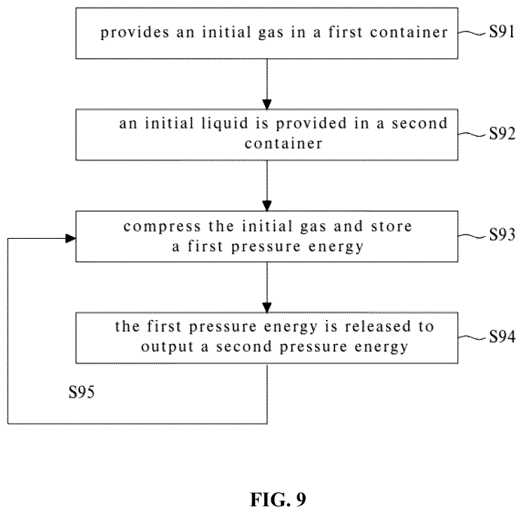

Referring to FIG. 9, a schematic flow chart shows the energy storage method using heterogeneous pressure media and interactive actuation according to an embodiment. In FIG. 9, the method starts at Step S91, which provides an initial gas in a first container.

At Step S92, an initial liquid is provided in a second container.

At Step S93, a working liquid is supplied to the second container to drive the initial liquid to compress the initial gas and store a first pressure energy.

At Step S94, the first pressure energy is released to drive the initial liquid to work on the working liquid to output a second pressure energy.

At Step S95, Steps S93 to S94 are performed to repeatedly act between the first pressure energy and the second pressure energy to output energy; for example, using the second pressure energy to drive a converter (such as a liquid pump, a turbo pump, liquid generator, liquid turbine generator, hydro turbine generator) to generate electricity.

In another embodiment, after Step S95, the working liquid is recovered to be applied to the second container again to form a closed system in which the working liquid can be repeatedly used.

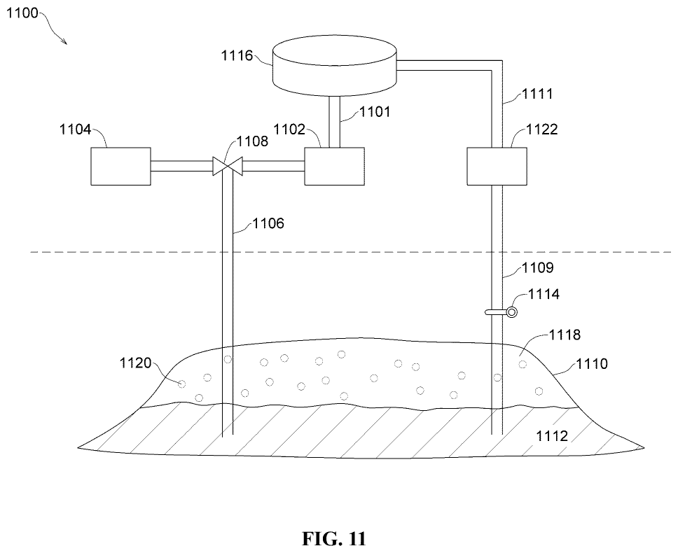

FIG. 11 illustrates a method 1100 of converting a system of compressed air energy storage (CAES) into a hydroelectric power storage system in accordance with some embodiments.

A CAES system can be rapidly converted into a hydroelectric power storage system, since the compressed air stored in the CAES can be readily converted for use as air or air-with-liquid storage in the hydroelectric power storage system disclosed herein. Normally, the compressed air in a typical CAES system can be maintained at a pressure of 40-80 bar, which is within a sufficiently high-pressure range for the hydroelectric power storage system disclosed above (e.g., FIGS. 1-10).

As shown in the FIG. 11, a first fluid pipe 1106 is coupled with/connected to a pump 1102 and an air compressor 1104 (as an example of a pressurizing unit) in accordance with some embodiments. Such connection can be altered from connecting to an air compressor 1104 in a typical CAES system. The storge (e.g., the container 1110) is now configured to storge pumped liquid and compressed air (e.g., from 2 atm-100 atm) (e.g., the air is compressed through the reduction of gas space in the container 1110 by adding/increasing the pumped liquid 1112 instead of pumped compressed air in a CAES system). The container 1110 can be above the ground, partially above the ground, and/or totally under the ground. In some embodiments, the containers 1110 are constructed/formed using natural/man-made geological features (e.g., caves, seabed, or underground oil field, or shale oil field) or pressure containers (e.g., steel and/or concrete structures).

In an operation mode of energy storage, the liquid source 1116 (e.g., lakes, rivers, sea water or water tank) is connected to a pump 1102 (e.g., a water pump, a pressurizing pump) through a liquid pipe 1101. The pump is connected to the container 1110 through the first fluid pipe 1106. In this embodiment, the liquid is water, flowing into the liquid pipe 1101 to the pump 1102, the pump 1102 further pumps water into the container 1110 (e.g., a storage or a closed space) through the first fluid pipe 1106. Through the gradually increased amount of water in the container 1110, the air space 1118 is gradually reduced. As a result, the pressure of the gas 1120 is increased in the container 1110 (e.g., a closed space). The increased pressure of the gas 1120 serves as a media of energy storage.

In this embodiment, the gas is air. In some embodiments, the gas is a noble gas. In this embodiment, the first valve 1108 is a three-way valve, used to control the flow direction of liquid from the liquid source 1116 and the flow direction of gas from the air compressor 1104. The second valve 1114 is located on the second fluid pipe 1109. The first valve 1108 and second valve 1114 are used to control the pumping in or out of the water, which (e.g., any or all of the valves disclosed herein) can be controlled by a computer system either with hard wires or remotely using control signals. In an energy storage mode, both the first valve 1108 and the second valve 1114 can be in a closed mode to maintain the pressure inside the container 1110. In some embodiments, a predetermined level of gas pressure P_{Default Pressure} (such as 5-20 atm) is maintained in the container 1110 before the water is pumped in. After the water is pumped into the container 1110, the pressure of energy storage (P_{storage}) can be increased to 20-80 atm. The difference of the energy state (E(P_{storage})-E(P_{Default Pressure})=E(Stored Energy)) is the energy stored.

In the operation mode of the electricity generation, the gas (Pressure (P_{storage})) inside the container 1110 pushes the liquid 1112 (e.g., water) into the second fluid pipe 1109, going to drive a hydro generator 1122 (e.g., hydro-turbine generator), so that electricity is generated.

In some embodiments, the energy storage systems using hydroelectric power generator are built underground, and the container 1110 is a cave. During the energy storage mode, the second valve 1114 is closed, and the air compressor 1104 injects gas into the container 1110, raising the gas pressure inside the container 1110 to a basic/threshold gas pressure. Next, the pump 1102 pumps liquid into the container 1110 continuously to further increase the gas pressure in the container 1110 to a predetermined pressure level due to the reduction of the available gas spaces. The difference between the predetermined pressure level and the basic gas pressure constitutes the stored pressure energy. In this embodiment, the basic gas pressure is 5 atm and the predetermined pressure level is 80 atm. When the gas pressure in the container 1110 reaches the predetermined pressure level of 80 atm through liquid (e.g., water) compression, the electricity generation mode can be initiated. During the electricity generation mode, the first valve 1108 is closed and the second valve 1114 is opened, allowing the gas pressure difference between the basic gas pressure and the predetermined pressure to drive the liquid through the second fluid pipe 1109 toward the hydro generator 1122, thereby driving the hydro generator 1122 to produce electricity. Thereafter, the liquid flows back to the liquid source 1116 through the third fluid pipe 1111, completing the circulation so the liquid can be reused in the energy storage mode. In the present disclosure, the basic gas pressure can be between 5-20 atm, for example 5, 6.2, 7.15, 8, 9, 10, 15, 20 atm, or specific values between the above values. The predetermined pressure level can be between 20-100 atm, for example 20, 30, 40, 50, 60, 70, 80, 90, 100 atm, or specific values between the above values.

In some embodiments, the container 1110 is located 1 to 2000 meters underground. The pressurizing energy derived from the pressure difference between the basic gas pressure and the predetermined pressure exceeds the potential energy difference between the liquid 1112 in the container 1110 and the liquid 1112 in the generator, enabling the liquid 1112 to flow into the generator (e.g., the hydro generator 1122). By the following formula, the gravitational potential energy of the liquid can be calculated:

Ep=mgh

wherein Ep is the potential energy in Joules (J), m is the mass of the object in kilograms (kg), g is the acceleration due to gravity in Newtons per kilogram (N/kg) or meters per second squared (m/s²), and h is the height in meters (m) above a reference point (e.g., location of the generator).

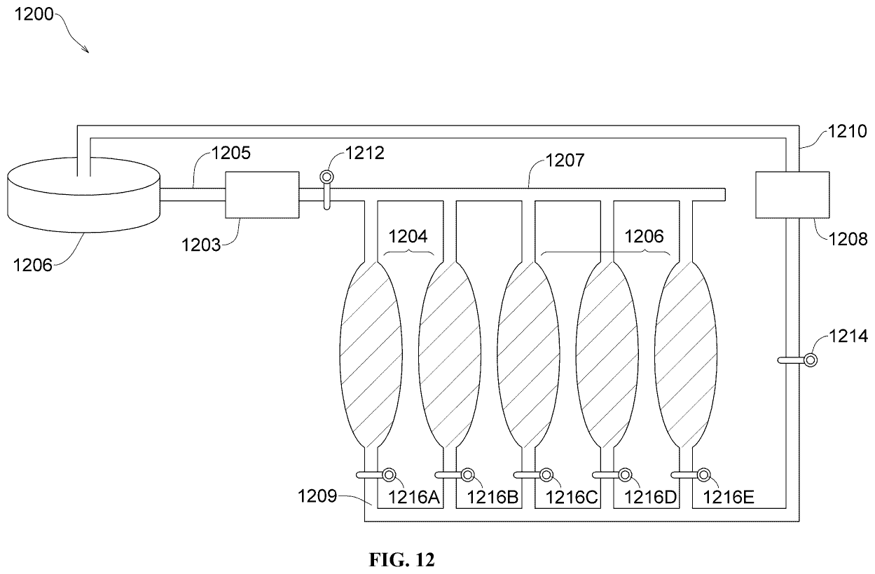

FIG. 12 illustrates an energy storage system (1200) using hydroelectric power generator in accordance with some embodiments.

Similar to the power storage system described above, this embodiment converts a CAES system to a hydroelectric power storage system. In some other embodiments, the containers 1204, 1206 that are used here can be originally designed/constructed for oil or any other gas storage, so long as the containers 1204, 1206 can withstand the pressure level needed in the hydroelectric power generation system here.

In this embodiment, containers 1204, 1206 constructed for CAES system can contain liquid containers 1204 for receiving pumped liquid and mixing containers 1206 for compressed air storage. In some embodiments, the liquid container or the mixing container has a height of 1 to 2 meters and a length of 7 to 20 meters. In some embodiments, a ratio of the mixing containers 1204 vs. the air containers 1206 is 4:6. Any other ratio of the mixing containers 1204 vs air containers 1206 are within the scope of the present disclosure.

Here, the operation of the system here can use the pump 1203 (e.g., a water pump) pumping liquid (e.g., water) from a liquid source 1206 (e.g., a water source). The liquid is pumped into the containers 1204, 1206. At this energy storage mode, a second valve 1214 is closed and a first valve 1212 is open, so that the liquid can be pumped into the mixing containers 1204, while the gas inside the air containers 1206 is kept inside the air containers 1206. As a result, the gas pressure of the gas insider the air containers 1206 is increased.

In a mode of electricity generation, the first valve 1212 is closed and the second valve 1214 is opened, such that the gas pressure in the air containers 1206 will push the liquid insider the mixing containers 1204 to be flowed through the valves 1216A and 1216B toward the hydro generator 1208 to generate electricity to be outputted for use. Each of the containers 1204, 1206 can contain one or more third valves 1216A-1216E to control the flow of the liquid/gas. The third valves 1216a-1216e can be controlled individually or in synchronized manner. In an example, the first valve 1212, the third valves 1216C, 1216D, and 1216E are closed, while the third valves 1216A, 1216B, and the second valve 1214 are opened, so that the liquid inside the mixing containers 1204 will be driven to flow to the hydro generator 1208 by the gas pressure inside the air containers 1206.

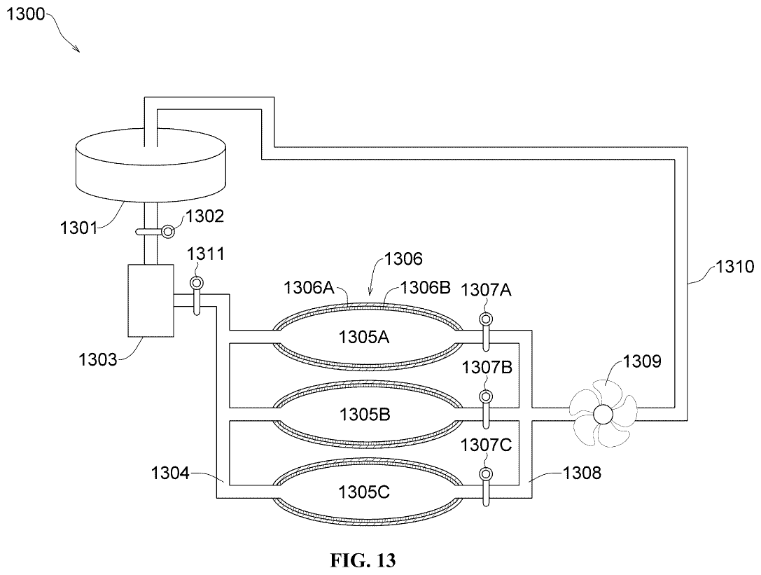

FIG. 13 illustrates a device (1300) for converting a compressed air energy storage into a hydroelectric power storage system in accordance with some embodiments. Similar to the system described above, the containers 1204, 1206 for CAES can be modified to be used as containers 1305a-c for the hydroelectric power generation/storage here. FIG. 13 illustrates an above ground storage system. The containers 1305A-1305C can be steel or concrete storage, or it can be petrol tank, gas tank, stainless steel tank or plastic tank.

In utilization, the device and systems are used to store and release energy so that such stored energy can be used on-demand.

In energy storage operation, the pump 1303 pumps the liquid (e.g., water) into the container 1305B (can be considered a mixing container) through the first fluid pipe 1304 and the air pressure inside the containers 1305A and 1305C is increased. In some embodiments, the water can be pumped into all or some of the containers 1305A, 1305B, and 1305C, which cause the reduction of air space inside the respective containers resulting a higher air pressure. In some embodiments, a default pressure (e.g., 20 atm) is inside the containers 1305A, 1305B, and 1305C before any water is pumped into the containers. During the energy storage mode, the valves 1307A-1307C are closed, and the liquid flows into the mixing containers 1305A, 1305C continuously, increasing the pressure in the air container 1305B until the gas pressure is increased to the predetermined level to store pressurized energy. In the electricity generation mode, when the valve 1311 is closed and valves 1307A and 1307C are opened, the pressurized energy forces the liquid stored in the mixing container 1305A, 1305C to flow toward the hydro generator 1309 through the second fluid pipe 1308, which drives the hydro generator 1309 to produce electricity. In this embodiment, the liquid is reusable. It can flow into the third fluid pipe 1310 and then be stored in the liquid source 1301. The valve 1302 is then opened and the pump 1303 pumps the liquid again into the containers 1305A, 1305B, 1305C to execute the next cycle of the energy storage mode.

As shown in FIG. 13, to enhance the structural strength of the containers 1305A-1305C, these containers 1305A-1305C have an outside layer 1306. The outside layer 1306 can be a single layer or a composite layer. In some embodiments, the outside layer 1306 is a layer 1306A formed with fiberglass, preferably the fiberglass is mesh. The fiberglass is also encapsulated with a polymer material (e.g., resin) to enhance its material strength and integrity. In some embodiments, the polymer material has a thickness of 0.5 to 5 centimeters.

Furthermore, the outside layer 1306 contains an inside polymer layer 1306B with a 0.5 to 5 centimeters thickness of a polymer material, which serves as a leaking prevention material because the polymeric material (such as polypropylene, polyethylene, and PVC) serves as a support and also as a filling among the openings of the mesh of the fiberglass in the pressure-change-induced expanding and shrinking process of the containers. The inside polymer layer 1306B can be a solid polymer layer (such as polypropylene, polyethylene, and PVC) that is capable of matching the expanding and shrinking stresses of the outer layer. In another embodiment, The outside layer 1306 does not contain the inside polymer layer 1306B. The inside polymer layer is disposed on the inner surface of some or all of the containers 1305A, 1305B, and 1305C.

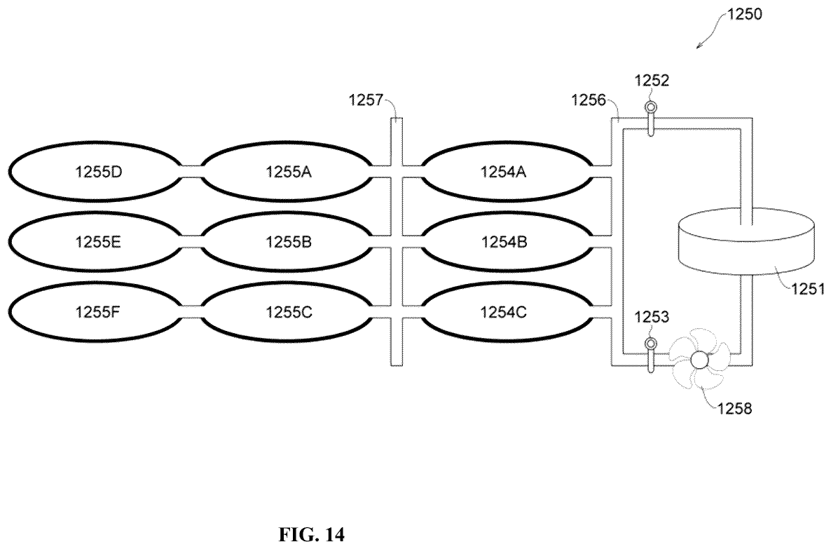

FIG. 14 illustrates an energy storage apparatus in accordance with some embodiments of the present disclosure.

As shown in FIG. 14, an energy storage apparatus 1250 comprises a liquid source 1251, gas tanks 1255A, 1255B, 1255C, 1255D, 1255E, 1255F, and mixing tanks 1254A, 1254B, 1254C, wherein the mixing tanks 1254A-1254C are communicated with the liquid source 1251 and the gas tanks 1255A-1255F. The energy storage apparatus 1250 may further comprise a first liquid pipe 1256 connecting the liquid source 1251 to the mixing tanks 1254A-1254C and second liquid pipe 1257 connecting the mixing tanks 1254A-1254C to the gas tanks 1255A-1255F. The gas tanks 1255A-1255F may be used for storing air or noble gas. In this embodiment, the gas tanks 1255A-1255F stores air. The gas tanks 1255A-1255F may have a basic gas pressure ranging from 5 to 20 atm (e.g, 5, 6, 6.2, 7, 7.15, 8, 9, 10, 15, 20 atm, or specific values between the above values). In energy storage operation, the valve 1252 is opened, the valve 1253 is closed, and the liquid (e.g., water) is pumped by a pump (not shown) into the mixing tanks 1254A-1254C. When the pumped liquid gradually increases the space occupied in the mixing tanks 154A-1254C by gradually increasing the volume in the mixing tanks 154A-1254C, thereby pushing air in the mixing tanks 1254A-1254C toward the gas tanks 1255A-1255F. The air pushed in the mixing tanks 1254A-1254C will then continuously compress the air in the gas tanks 1255A-1255F, until the air in the gas tanks 1255A-1255F reaches a predetermined pressure (e.g., 20, 30, 40, 50, 60, 70, 80, 90, 100 atm, or specific values between the above values). When the energy storage mode of the energy storage apparatus is executed, the liquid preferably does not go in the gas tanks1255A-1255F.

In electricity generation operation, when the valve 1253 is opened (the valve 1252 is in the closed position), the air reaching the predetermined pressure will push the liquid in the mixing tanks 1254A-1254C to flow toward a generator 1258 (e.g., hydroelectric power generator) to drive the generator 1258 to generate electricity.

In some embodiments, the mixing tank is caves, seabed, oil field or shale oil field.

In some embodiments, the mixing tank is placed underground.

In some embodiments, the gas tank is an air compressor.

In some embodiments, the mixing tank is provided with a high water level detector configured to detect liquid (e.g., water) volume and stop pumping liquid when the liquid volume reaches the predetermined level (e.g., high water level threshold).

In some embodiments, the mixing tank is provided with a low water level detector configured to detect liquid (e.g., water) volume and pump liquid when the liquid volume lower than a predetermined level (e.g., low water level threshold). The high or low water level detector can be a water sensor, which sends a signal when the sensor is in contact or non-contact of water (e.g., sense of a change of a status), so that pumping water to stop pumping water can be determined and controlled.

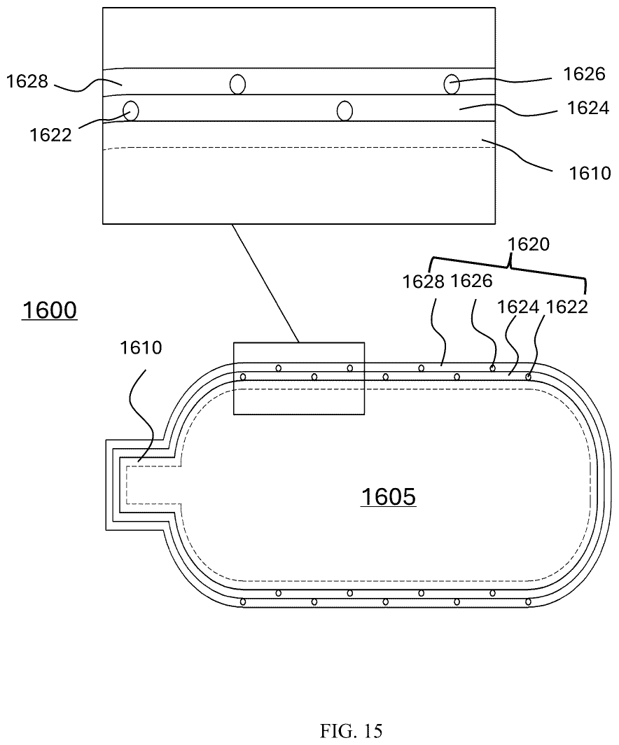

FIG. 15 is a cross-sectional view of a mixing tank according to an embodiment of the present disclosure.

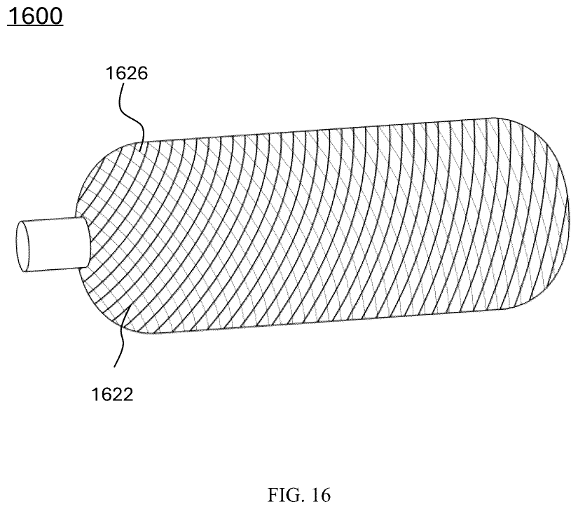

FIG. 16 is a schematic diagram of a mixing tank.

As shown in the FIG. 15, the mixing tank 1600 (or the gas tank) comprises a polymeric inner layer 1610 disposed on an inner surface of the mixing tank 1600. In this embodiment, the polymeric inner layer 1610 can be used to prevent gas (e.g., air or noble gas) leakage. The polymeric inner layer 1610 can be a solid polymer layer, and can be made of polypropylene, polyethylene, or polyvinyl chloride (PVC). In this embodiment, the polymeric inner layer 1610 is made of polypropylene. The polymeric inner layer preferably has a thickness at least 1 centimeter (e.g., 1.2 cm, 1.5 cm, 1.7 cm, 2 cm, 2.5 cm, 3 cm, 4 cm, 5 cm, or specific values between the above values) to prevent it from being deformed by high pressure.

The mixing tank 1600 may further comprise an external protection layer 1620 disposed on an outer surface of the mixing tank 1600. In this embodiment, the external protection layer 1620 comprises a first fiber-reinforced polymer layer 1622; a first cured resin layer 1624 encapsulating the first fiber-reinforced polymer layer 1622; a second fiber-reinforced polymer layer 1626 deposed on the first cured resin layer; and a second cured resin layer 1628 encapsulating the second fiber-reinforced polymer layer. These layers define an interior chamber 1605. The fiber-reinforced polymer layer 1622 is formed by winding a fiber-reinforced polymer around the outer surface. The second fiber-reinforced polymer layer 1626 is formed by winding a fiber-reinforced polymer around the first cured resin layer. The first and second fiber-reinforced polymer layer are made of the same material. As shown in FIG. 16, in this embodiment, the first fiber-reinforced polymer layer 1622 and second fiber-reinforced polymer layer 1626 are interwoven to form on the outer surface of the container. The first fiber-reinforced polymer layer 1622 and second fiber-reinforced polymer layer 1626 are woven at an angle 35-55 degrees from the wall of the tank.

The external protection layer 1620 have a thickness of 0.5 to 5 centimeters. The mixing tank 1600 have a thickness (e.g., a diameter of inner open space) of 1-2 meters and a length of 7-20 meters.

The above layered structure may be used in the gas tank.

In some embodiments, the gas tank has the same layered structure as the mixing tank.

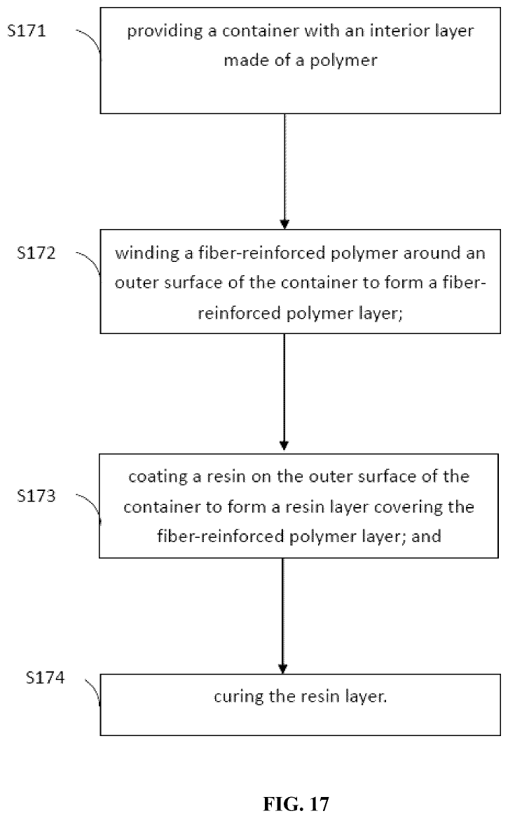

FIG. 17 is a flow chart illustrating a method for manufacturing an energy storage.

In FIG. 17, the method starts at Step S171, which provides a container with an interior layer made of a polymer. The polymer may be polypropylene, polyethylene, or polyvinyl chloride (PVC).

At Step S172, a fiber-reinforced polymer is wound around an outer surface of the container to form a fiber-reinforced polymer layer.

At Step S173, a resin is coated on the outer surface of the container to form a resin layer covering the fiber-reinforced polymer layer.

At Step S174, the resin layer is cured.

In some embodiments, the fiber-reinforced polymer layer is a first fiber-reinforced polymer layer, the resin layer is a first resin layer, and the method further comprises winding the fiber-reinforced polymer around the first resin layer to form a second fiber-reinforced polymer layer; coating the resin on the outer surface of the container to form a second resin layer covering the second fiber-reinforced polymer layer; and curing the second resin layer.

In some embodiments, the first fiber-reinforced polymer layer and second fiber-reinforced polymer layer are interwoven to form the outer surface of the container.

In some embodiments, the container is selected from petrol tank, gas tank, stainless steel tank, concrete tank or plastic tank.

The energy storage can be the mixing tank or the gas tank mentioned above.

The present disclosure also provides a method of compressed air energy storge (CAES) into a hydroelectric power storage system comprising fluidly coupling a water pump to one or more containers constructed for storing compressed air of a compressed air energy storage; and fluidly coupling a hydroelectric power generator to the one or more containers

In some embodiments, the method further comprises constructing a water pipe connecting the water pump and the one or more container.

In some embodiments, the method further comprises constructing a water pipe connecting the hydroelectric power generator and the one or more container.

The present invention has been disclosed in preferred embodiments above, but those skilled in the art should understand that this embodiment is only used to describe the present invention and should not be construed as limiting the scope of the present invention. It should be noted that all changes and substitutions equivalent to this embodiment should be included in the scope of the present invention. Therefore, the protection scope of the present invention shall be defined by the scope of the patent application.

What is claimed is:

1. An energy storage system comprising:
a container having a base pressure;
a pressurizing pump configured to pump a liquid to the container;
a liquid source configured to supply the liquid through the pressurizing pump to the container so that the gas pressure is increased from the base pressure to a first level pressure.

2. The system of claim 1, further comprising a generator configured to receive the liquid discharged from the container to generate electricity by reducing the gas pressure from the first level pressure to be a lower second level.

3. The system of claim 1, wherein the base pressure ranges from 5 to 20 atm.

4. The system of claim 1, wherein the base pressure is a baseline pressure as a default pressure of the energy storage system.

5. The system of claim 3, wherein the container is selected from a caves, seabed, oil field or shale oil field and the container is placed underground.

6. The system of claim 1, wherein the container is selected from petrol tank, gas tank, stainless steel tank, concrete tank or plastic tank, and the container is wound with a fiber-reinforced polymer.

7. The system of claim 6, wherein the container is further overlapped with a polymer material and the fiber-reinforced polymer is encapsulated by the polymer material.

8. The system of claim 7, wherein the polymer material has a thickness of 0.5 to 5 centimeters.

9. An energy storage apparatus comprising:
a liquid source;
a gas tank; and
a mixing tank communicated with the liquid source and the gas tank,
wherein at least one of the gas tank and the mixing tank comprises a polymeric inner layer disposed on an inner surface of the gas tank or the mixing tank.

10. The apparatus of claim 9, wherein the polymeric inner layer has a thickness of at least 1 centimeter.

11. The apparatus of claim 9, wherein the polymeric inner layer is made of polypropylene, polyethylene, or polyvinyl chloride.

12. The apparatus of claim 9, further comprising an external protection layer disposed on an outer surface of at least one of the gas tank and the mixing tank, wherein the external protection layer comprises a fiber-reinforced polymer layer formed by winding a fiber-reinforced polymer around the outer surface.

13. The apparatus of claim 12, wherein the external protection layer further comprises a cured resin layer encapsulating the fiber-reinforced polymer layer.

14. The apparatus of claim 9, wherein at least one of the gas tank and the mixing tank has a length of 7 to 20 meters.

15. The apparatus of claim 9, wherein at least one of the gas tank and the mixing tank has a height of 1 to 2 meters.

16. The apparatus of claim 13, wherein the cured resin layer has a thickness of 0.5 to 5 centimeters.

17. The apparatus of claim 9, wherein the mixing tank is selected from a caves, seabed, oil field or shale oil field and the container is placed underground.

18. A method for manufacturing an energy storage comprising:
providing a container with an interior layer made of a polymer;
winding a fiber-reinforced polymer around an outer surface of the container to form a fiber-reinforced polymer layer;
coating a resin on the outer surface of the container to form a resin layer covering the fiber-reinforced polymer layer; and
curing the resin layer.

19. The method of claim 17, wherein the fiber-reinforced polymer layer is a first fiber-reinforced polymer layer, the resin layer is a first resin layer, and the method further comprises winding the fiber-reinforced polymer around the first resin layer to form a second fiber-reinforced polymer layer; coating the resin on the outer surface of the container to form a second resin layer covering the second fiber-reinforced polymer layer; and curing the second resin layer.

20. The method of claim 19, wherein the first fiber-reinforced polymer layer and second fiber-reinforced polymer layer are interwoven to form on the outer surface of the container.

21. The method of claim 18, wherein the polymer is selected from polypropylene, polyethylene, or polyvinyl chloride.
